(19) United States
(12) Patent Application Publication
(10) Pub. No.: US 2005/0242053 A1
(43) Pub. Date: Nov. 3, 2005

(54) System for self-lubricating a coupling system

(75) Inventors: David C. Brabb, Chicago, IL (US); David W. Daugherty JR., Crown Point, IN (US)

Correspondence Address: JAMES RAY & ASSOCIATES, 2640 PITCAIRN ROAD, MONROEVILLE, PA, 15146, US

(73) Assignee: WESTINGHOUSE AIR BRAKE TECHNOLOGIES CORPORATION

(21) Appl. No.: 10/837,834

(22) Filed: May 3, 2004

(51) Int. Cl. F16C 11/00; B61G 9/00

(52) U.S. Cl. 213/64; 403/135; 213/75 R

(57) ABSTRACT

A device for providing self-lubrication to a slackless coupling system for a railway vehicle, specifically an articulated connector. The device comprises a self-lubricating member having a predetermined size and shape. The self-lubricating member is integrally formed from a non-stick material. The self-lubricating member has an inner surface and an outer surface, whereby such non-stick material will provide sufficient lubrication between the inner surface of the self-lubricating member, and a first surface of a spherical member coming in contact with the inner surface of the self-lubricating member, thereby allowing unrestricted movement of such spherical member there against, thus causing a reduction in L/V ratio when such self lubricating member is used in such coupling system.

### CROSS-REFERENCE TO RELATED APPLICATION

The invention taught in the present application is closely related to the invention taught in U.S. Pat. No. 6,390,313 B1, “Slackless Drawbar Assembly Using An Improved Ball and Race Connection Assembly”. This patent is assigned to the assignee of the present application. The teachings of this patent are incorporated herein by reference thereto.

The present invention relates, in general, to a self-lubricating system, and more particularly, to a self-lubricating system for a slackless coupling system for a railcar.

### BACKGROUND OF THE INVENTION

Prior to the present invention, a slackless coupling system for a railcar requires periodic lubrication in order to perform efficiently. Typical examples of slackless coupling systems are railcar drawbars and articulated connectors. One type of a slackless-type coupling system uses a ball and race connection assembly. The ball member has a sufficiently smooth surface. Currently used ball member surfaces include electroless nickel-plated, chrome plated, or the like to improve the corrosion resistance of the ball member. The race connection assembly comprises a metal member having a machined surface. This race connection assembly surrounds the ball member so that the ball can rotate within the race assembly and allow the angling movements and maneuverability required to properly negotiate railway track geometry. With the slack removed, greater frictional forces are exerted between the spherical surfaces and the connecting parts. In order to ensure unrestricted movement of the ball member with the race member, care must be taken to ensure that the contacting surfaces are machined to a requisite smoothness. In order to overcome these forces, slackless coupling system manufacturers specify periodic maintenance requirements, such as grease or silicon lubrication at regular intervals to maintain maximum performance, increase product life, and improve efficiency. One known technique for obtaining this lubrication is to provide a substantially solid lubricating liner member, such as manufactured by Kahr Bearing Company, and marketed by them under the trade name “KARLON”, disposed between the outer surface of the ball member, and the inner surface of the race assembly.

Although many lubricating techniques are well known in the art, it is still difficult to maintain a reduced amount of friction between rotating metal-to-metal surfaces. Additionally, machining of both the ball member and the race member to sufficient smoothness and continuously providing adequate lubrication between the ball and race surfaces can be costly and time consuming.

The railway industry is continuously seeking ways to cut costs whether these cuts be in the cost of materials, labor-manufacturing costs, and/or in maintenance costs. Another way to cut costs is to reduce the weight of the freight cars and components for connecting the cars together. This reduction in weight allows for a reduction in the amount of energy or fuel used to pull the train, which ultimately results in higher payloads. Although higher payloads are the ultimate goal of manufacturers, a high level of safety must be maintained.

One way to measure the safety of the railway vehicle is through what is known as an L/V ratio, which is the lateral force over the vertical force of the vehicle. An acceptable L/V ratio limit, as established by the Mechanical Committee of the Standard Coupler Manufacturers (MCSCM) is 0.82, and the recommended L/V ratio limit is less than or equal to 0.74. As manufacturers reduce the weight of these cars, care must be taken to ensure that the L/V ratio is not exceeded. If the L/V ratio exceeds the acceptable limit, the lateral force on the car(s) during turning can exceed the vertical force of the car's weight on the wheels, thus causing the wheels of the car(s) to lift off of the track and the train to derail.

One of the ways in which the L/V ratio can be reduced is by reducing the amount of friction in the joint between the male and female connection members of the coupling system.

### SUMMARY OF THE INVENTION

The present invention provides self-lubrication to a slackless coupling system for a railway vehicle. A self-lubricating member having a predetermined size and shape is integrally formed from a non-stick material. The self-lubricating member has an inner surface and an outer surface. The non-stick material provides sufficient lubrication between the inner surface of the self-lubricating member, and a first surface of a spherical member coming in contact with the inner surface of the self-lubricating member. The non-stick material of the self-lubricating member allows unrestricted movement of the spherical member, which causes a reduction in the L/V ratio when the self-lubricating member is used in a railcar coupling system.

### OBJECT OF THE INVENTION

It is therefore a primary object of the present invention to provide self-lubrication to a slackless coupling system for a railway vehicle.

It is a further object of the present invention to minimize manufacturing costs and time by providing adequate lubrication between the ball and race members of a slackless coupling system.

Still a further object of the present invention is to maintain a reduced amount of friction between rotating metal-to-metal surfaces of a slackless coupling system.

Still a further object of the present invention is to prevent train derailment by reducing the L/V ratio.

In addition to the various objects of the invention that have been described above, various other objects and advantages will become more readily apparent to those persons skilled in the relevant art from the following more detailed description of the invention, particularly, when such description is taken in conjunction with the attached drawing figures and the appended claims.

### BRIEF DESCRIPTION OF THE DRAWINGS

FIG. 1 is an exploded view of a presently preferred embodiment of a self-lubricating device for a slackless coupling system, specifically an articulated connector for a railway vehicle;

FIG. 2 is an isometric view of the assembled articulated connector with the self lubricating device; and

FIG. 3 is an exploded view of a presently preferred embodiment of a self-lubricating device for an alternate slackless coupling system for a railway vehicle, specifically a slackless drawbar.

### BRIEF DESCRIPTION OF A PRESENTLY PREFERRED AND VARIOUS ALTERNATIVE EMBODIMENTS OF THE PRESENT INVENTION

Prior to proceeding to a more detailed description of the invention, it should be noted that identical components having identical functions have been designated with identical reference numerals for the sake of clarity.

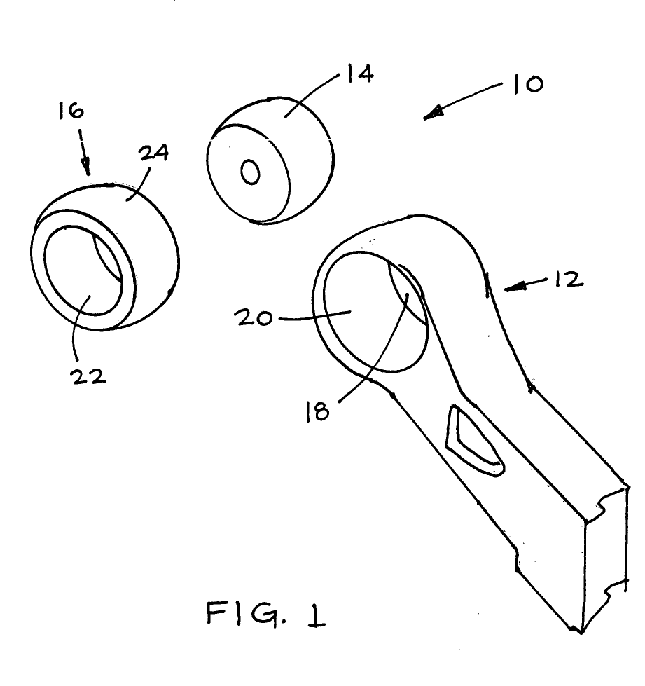

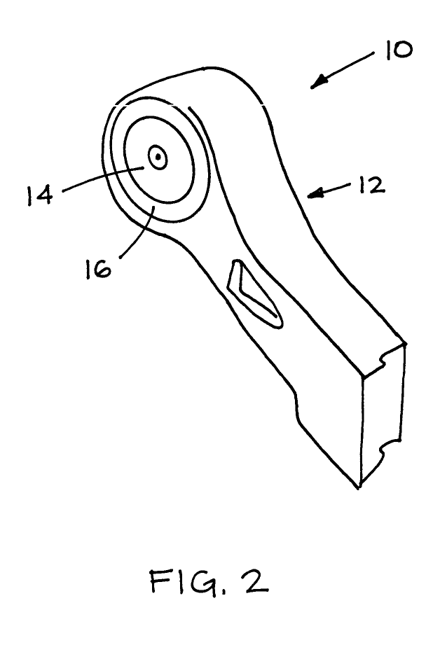

Now refer more particularly to FIGS. 1 and 2 of the drawings. Illustrated therein is a ball and race connection assembly, generally designated 10, for an articulated connector, comprising a male connection member, generally designated 12, a spherical member 14, and a self lubricating member, generally designated 16. The male connection member further comprises an aperture 18, and an inner surface 20. The self-lubricating member 16 further includes an inner surface 22, and an outer surface 24. The self-lubricating member 16 has a predetermined size and shape. Preferably, the shape of the inner surface 20 is spherical, and the shape of the outer surface 22 is cylindrical. The self-lubricating member 16 is formed from a non-stick material. Preferably, the non-stick material is a filament wound resin impregnated material. More preferably, the resin impregnated filament wound material is at least one of Dacron and Teflon material, having an L/V ratio of less than or equal to 0.74.

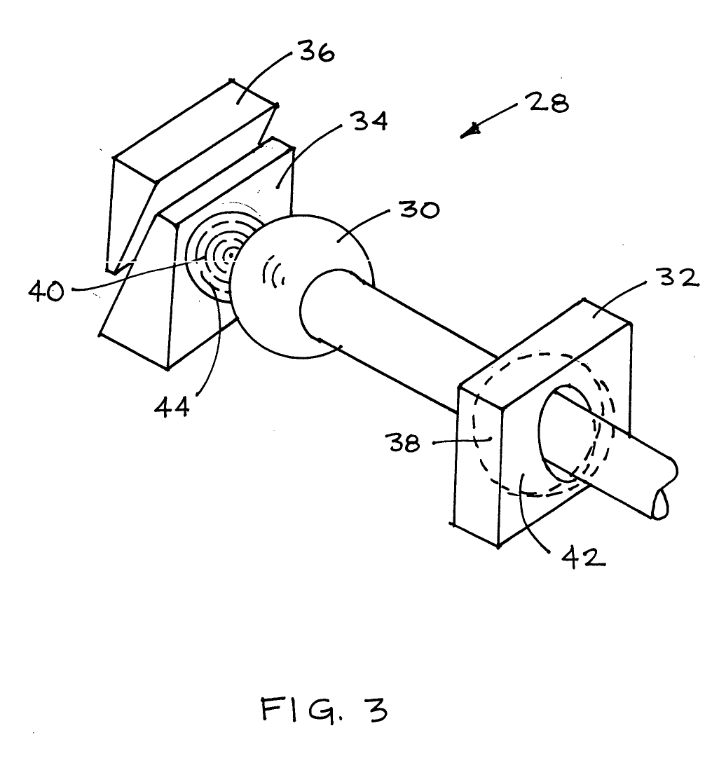

Now refer more particularly to FIG. 3 of the drawings. Illustrated therein is a ball and race connection assembly, generally designated 28, for a slackless drawbar system, comprising a spherical member 30, and a front follower 32. The front follower 32 has a spherical inner surface 38. A first self-lubricating member 42 is disposed about the spherical concave surface 38 of the front follower 32. The first self-lubricating member 42 has a predetermined size and shape. Preferably, the shape of the first self-lubricating member 42 is spherical. The self-lubricating member 42 is formed from a non-stick material. Preferably, the non-stick material is a filament wound resin impregnated material. More preferably, the resin impregnated filament wound material is at least one of Dacron and Teflon material, having an L/V ratio of less than or equal to 0.74.

Now refer more particularly to FIG. 3 of the drawings. Illustrated therein is a ball and race connection assembly, generally designated 28, for a slackless drawbar system, comprising a spherical member 30, a rear follower 34, and a gravity wedge 36. The rear follower has a spherical inner surface 40. A second self-lubricating member 44 is disposed about the spherical concave surface of the rear follower 34. The second self-lubricating member 44 has a predetermined size and shape. Preferably, the shape of the second self-lubricating member 44 is spherical. The second self-lubricating member 44 is formed from a non-stick material. Preferably, the non-stick material is a filament wound resin impregnated material. More preferably, the resin impregnated filament wound material is at least one of Dacron and Teflon material, having an L/V ratio of less than or equal to 0.74.

Now refer again more particularly to FIG. 3 of the drawings. Illustrated therein is a ball and race connection assembly, generally designated 28, for a slackless drawbar system, comprising a spherical member 30, a front follower 32, a rear follower 34, and a gravity wedge 36. The front follower 32 has a spherical inner surface 38. The rear follower has a spherical inner surface 40. A first self-lubricating member 42 is disposed about the spherical concave surface 38 of the front follower 32. A second self-lubricating member 44 is disposed about the spherical concave surface of the rear follower 34. The first self-lubricating member 42 has a predetermined size and shape, and the second self-lubricating member 44 has a predetermined size and shape. Preferably, the shape of the first self-lubricating member 42 is spherical, and the shape of the second self-lubricating member 44 is spherical. The self-lubricating members 42 and 44, respectively, are formed from a non-stick material. Preferably, the non-stick material is a filament wound resin impregnated material. More preferably, the resin impregnated filament wound material is at least one of Dacron and Teflon material, having an L/V ratio of less than or equal to 0.74.

1. A device for providing self-lubrication to a slackless coupling system for a railway vehicle, specifically an articulated connector, said device comprising:
a) a self-lubricating member having a predetermined size and shape, said self-lubricating member integrally formed from a non-stick material, said self-lubricating member further having an inner surface and an outer surface, whereby said non-stick material will provide sufficient lubrication between said inner surface of said self lubricating member, and a first surface of a spherical member coming in contact with said inner surface of said self-lubricating member, thereby allowing unrestricted movement of such spherical member there against, thus causing a reduction in L/V ratio when said self-lubricating member is used in such coupling system.

2. The device according to claim 1 wherein said self-lubricating member is formed by a resin impregnated filament wound material.

3. The device according to claim 2 wherein said resin impregnated filament wound material is at least one of Dacron and Teflon material.

4. The device according to claim 2 wherein said resin impregnated filament material results in an L/V ratio of less than or equal to 0.74.

5. The device according to claim 1 wherein the shape of said inner surface is spherical, and the shape of said outer surface is cylindrical.

6. A device for providing self-lubrication to a slackless coupling system for a railway vehicle, specifically a slackless drawbar, said device comprising:
a) a spherical drawbar member,
b) a front follower having a first spherical concave surface,
c) a first self lubricating member disposed about such first spherical concave surface of such front follower, said first self-lubricating member having a predetermined size and shape, and being integrally formed from a non-stick material, said first self-lubricating member further having a first inner, whereby said non-stick material will provide sufficient lubrication between said first surface of said first self-lubricating member, and said convex surface of such spherical drawbar member coming in contact with said first inner surface of said first self-lubricating member, thereby allowing unrestricted movement of such spherical member there against, thus causing a reduction in L/V members are used in such coupling system.

7. The device according to claim 6 wherein said first self-lubricating member is formed by a resin impregnated filament wound material.

8. The device according to claim 7 wherein said resin impregnated filament wound material is at least one of Dacron and Teflon material.

9. The device according to claim 7 wherein said resin impregnated filament material results in an L/V ratio of less than or equal to 0.74.

10. The device according to claim 6 wherein the shape of said first self-lubricating member is spherical.

11. A device for providing self-lubrication to a slackless coupling system for a railway vehicle, specifically a slackless drawbar, said device comprising:
a) a spherical drawbar member,
b) a rear follower having a second spherical concave surface,
c) a gravity wedge,
d) a second self-lubricating member disposed about such spherical concave surface of such rear follower, said second self-lubricating member having a predetermined size and shape, and being integrally formed from a non-stick material, said second self-lubricating member further having a second inner surface, whereby said non-stick material will provide sufficient lubrication between said second inner surface of said second self lubricating member, and said convex surface of such spherical drawbar member coming in contact with said second inner surface of said second self-lubricating member, thereby allowing unrestricted movement of such spherical member there against, thus causing a reduction in L/V members are used in such coupling system.

12. The device according to claim 11 wherein said second self-lubricating member is formed by a resin impregnated filament wound material.

13. The device according to claim 12 wherein said resin impregnated filament wound material is at least one of Dacron and Teflon material.

14. The device according to claim 12 wherein said resin impregnated filament material results in an L/V ratio of less than or equal to 0.74.

15. The device according to claim 11 wherein the shape of said second self-lubricating member is spherical.

16. A device for providing self-lubrication to a slackless coupling system for a railway vehicle, specifically a slackless drawbar, said device comprising:
a) a spherical drawbar member,
b) a front follower having a first spherical concave surface,
c) a rear follower having a second spherical concave surface,
d) a gravity wedge,
e) a first self lubricating member disposed about such first spherical concave surface of such front follower, said first self-lubricating member having a predetermined size and shape, being integrally formed from a non-stick material and further having a first inner surface; and
f) a second self lubricating member disposed about such spherical concave surface of such rear follower, said second self-lubricating member having a predetermined size and shape, being integrally formed from a non-stick material and further having a second inner surface respectively, whereby said non-stick material will provide sufficient lubrication between said first and second inner surfaces of said first and second self lubricating members, and said convex surface of such spherical member coming in contact with said first and second inner surfaces of said first and second self lubricating members, thereby allowing unrestricted movement of such spherical member there against, thus causing a reduction in L/V members are used in such coupling system.

17. The device according to claim 16 wherein said first and second self lubricating members are formed by a resin impregnated filament wound material.

18. The device according to claim 17 wherein said resin impregnated filament wound material is at least one of Dacron and Teflon material.

19. The device according to claim 17 wherein said resin impregnated filament material results in an L/V ratio of less than or equal to 0.74.

20. The device according to claim 16 wherein the shape of said first self-lubricating member is spherical, and the shape of said second self-lubricating member is spherical.
